(19) United States
(12) Patent Application Publication
(10) Pub. No.: US 2012/0090512 A1
(43) Pub. Date: Apr. 19, 2012

(54) Drill Press Table

(76) Inventors: Michael Louis DETTLING, Clarkston, MI (US); Debra Dianne Dettling, Clarkston, MI (US)

(21) Appl. No.: 13/252,623

(22) Filed: Oct. 4, 2011

Related U.S. Application Data
(60) Provisional application No. 61/393,488, filed on Oct. 15, 2010.

(51) Int. Cl. B23Q 3/00

(52) U.S. Cl. 108/42

(57) ABSTRACT

The present invention allows a drill press operator to quickly and securely clamp different objects to a drill press or mill with simple handheld C-clamps or standard C-clamps. It employs the use of a uniquely shaped plate that clamps to the existing drill press or mill table. It has an concave edge cut into the front edge that allows small objects to be clamped in close quarters. The present invention can be customized into different sizes are available to accommodate different size drill press tables.

The current application claims a priority to the U.S. Provisional Patent application Ser. No. 61/393,488 filed on Oct. 15, 2010.

### FIELD OF THE INVENTION

The present invention relates generally to a raised table that can be clamped atop a drill press or mill table. The present invention allows the use of handheld C-clamps or other standard C-clamps to clamp the work piece quickly and securely to the table top.

### BACKGROUND OF THE INVENTION

People who are experienced with a drill press or mill table are aware that any piece of work being used on the machine must be securely attached to the surface of the table. Current drill presses use drill press vises to clamp material to the drill press table. While the drill press vises work for certain sizes of work pieces, they are not versatile enough for more unique sizes of work pieces such as long pieces of tube stock or large pieces of flat stock. Another issue with current drill presses is the lack of a protective surface for the drill press table. Eventually the original table may rust or become damaged from all the wear the drill bits will exert on the table. The present invention seeks to eliminate both of these concerns. The present invention is an additional tabletop that can be clamped on top of the drill press' original table to decrease the damage caused to the original table. Also, the unique design elements of the present invention allow virtually any size work piece to be securely clamped on.

### BRIEF DESCRIPTION OF THE DRAWINGS

FIG. 1 is a section cut of the bottom view of the present invention.

FIG. 2 is a section cut of the front plan view of the present invention.

FIG. 3 is a section cut of the left view of the present invention.

FIG. 4 is a perspective view of the present invention.

### DETAIL DESCRIPTIONS OF THE INVENTION

All illustrations of the drawings are for the purpose of describing selected versions of the present invention and are not intended to limit the scope of the present invention.

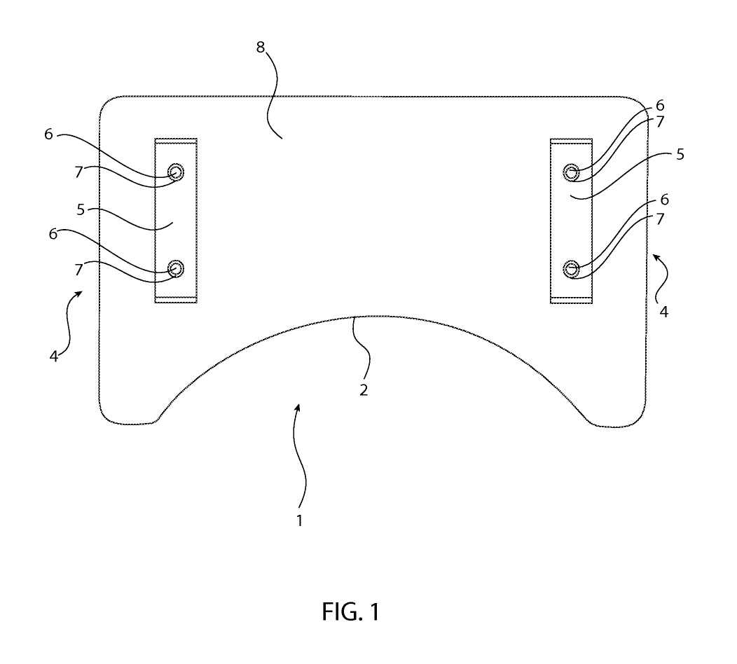

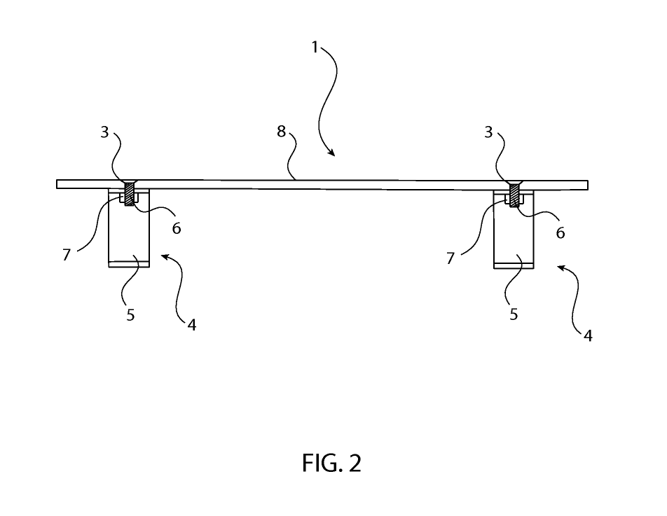

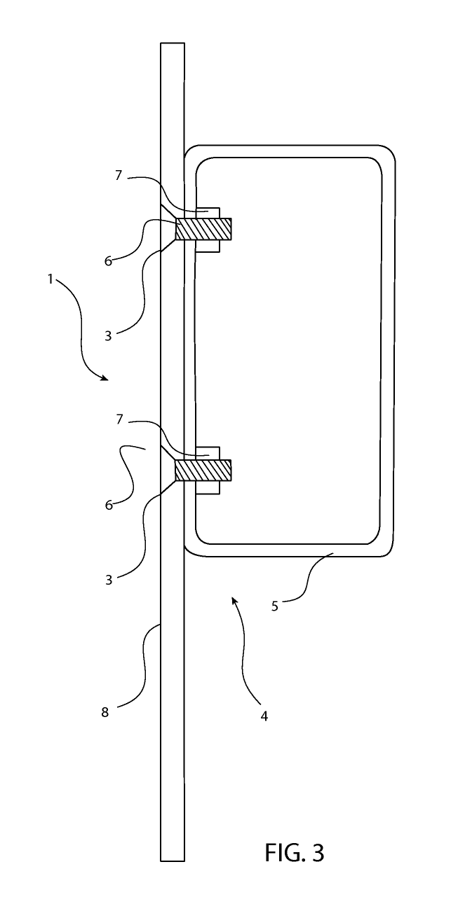

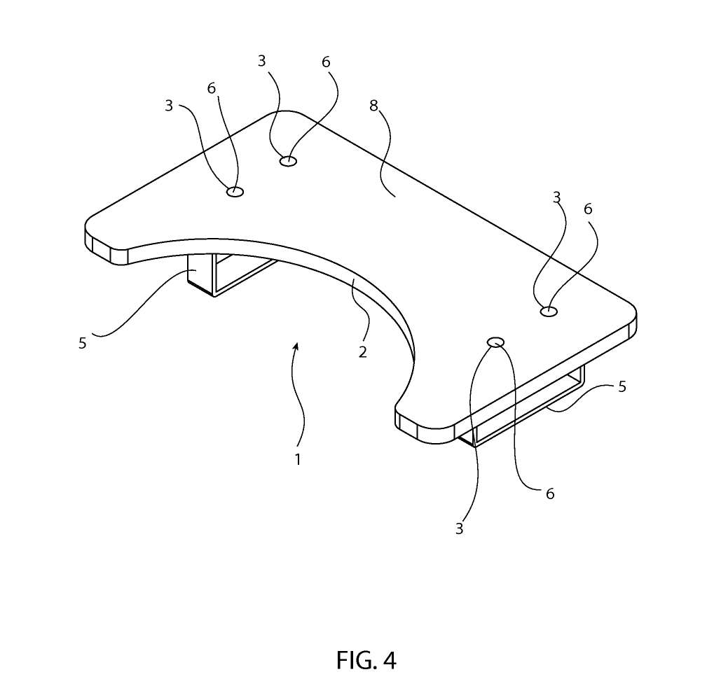

In reference to FIG. 1, FIG. 2, FIG. 3, and FIG. 4, the present embodiment of the drill press table contains two major distinct parts, the table 1 and the support system 4. The table 1 further comprises of a tabletop plate 8, a concave edge 2, and a plurality of holes 3. Also, the support system 4 comprises of a plurality of support legs 5, a plurality of flat head screws 6, and a plurality of locking nuts 7.

In reference to FIG. 1, FIG. 2, FIG. 3, and FIG. 4, the tabletop plate 8 is a five-sixteenths inch-thick steel plate. The actual dimension of the tabletop plate 8, and as a result the table 1, can vary. Common sizes fall into the range of eight inches by twelve inches to twelve inches by twenty inches. However, the drill press table is not limited to these sizes alone. Customizable sizes can be created to fit whatever unique size the drill press is. The ability to customize the size of the drill press table allows the product to be used by nearly any drill press, thus increasing the versatility of the apparatus. While the size of tabletop plate 8 can vary, the basic design elements, which include the concave edge 2 and the plurality of holes 3, remain constant, allowing it to work in any circumstance.

Referring to FIG. 4, the material of the table 1 is another instance of some variation of the drill press table. The present invention uses steel for the material of the table 1. However, the material of the present invention is not limited to steel alone. Other equally strong or stronger materials (i.e. other metals) may also be used. A strong material will be less affected by the drill press than others. The probability of the drill bit creating a hole or an impression decreases significantly when the table 1 is made from a strong material. Another benefit of using a strong material is that it decreases the chances of the table breaking from the pressure of the drill press. If a material such as acrylic were used, the danger of cracking midst use is much greater than when using steel. Another risk of using a weaker material is the ability to break when clamping the work piece of the table 1. Since the clamp places pressure on the table 1 to securely lock the work piece to the table, the pressure could cause the table 1 to crack if the material of the table was too weak.

Again referring to FIG. 4, another advantage to the drill press table is that its table 1 can be cut with a water jet or plasma cutter. This is beneficial because using a water jet or a plasma cutter requires less time to customize the dimensions for the table 1 because both processes are quick in comparison to other methods of manufacturing the table 1. The plasma cutting process involves using a pressurized inert gas and electrodes to create a spark that is hot enough to easily cut through metal. Since the basis of this method of cutting involves high temperatures, it can cut through metal easily and efficiently. The other process that may be used is the water jet in which highly pressurized water is used to cut through the metal.

Referring to FIG. 1 and FIG. 4, a unique design component to the drill press is its concave edge 2 feature. The concave edge 2 is cut into the front of the tabletop plate 8. In the present embodiment, the concave edge 2 is shaped as an arc that is curved inwards. The present invention is not limited to this design of the concave edge. Other designs include, but are not limited to, even a triangle in which two straight edges travel inwards at a diagonal to create a vertex instead of one curved edge. A benefit of the concave edge 2 is that the drill press table can now provide easy clamping of small work pieces close to the drill point. Often times, smaller pieces of material are difficult to keep steady on the drill press and/or mill table because the original table of the machine is much too large when compared to the piece of material. Therefore, clamps that are used to secure the work piece onto the original table are not long enough to reach the unusually small work piece. As a result, the small work piece cannot be as securely attached to the drill press table as other work pieces can be. This can pose as a potential danger to the user of the drill press because of the moving cutting tool within all the machines. Without the secure attachment, the work piece can unexpectedly move while the drill press is in use, which can lead to injuries for the user. Another problem with typical drill press tables and drill press vises is their inability to fit too large work pieces. A standard drill press vise will not be able to securely clamp onto the large piece because it may simply be too small in comparison. Also, another advantage is that tube stock can now be easily clamped onto the table 1. In traditional drill presses, it is difficult to clamp tube stock because of how large it is and how limited the drill press vise is in its clamping clearances. The method of clamping with C-clamps or handheld C-clamps is much easier than using the drill press vise, which is the more often suggested clamp to use for clamping work pieces to the drill table. However, despite it being a more general clamp to use for any drill press, the drill press vise still has problems with clamping too large or too small work pieces. The convenience of the drill press table is the ability to use any type of C-clamp to secure the work piece to the table 1. The C-clamp can provide a large clearance for the work piece as opposed to the drill press which is convenient if the work piece is too large. Also, the C-clamp will also help to secure work pieces that may be too small for a drill press vise. The other option of clamping, the handheld C-clamps, is easy to use and handle when compared other types of clamps because of the grips on the clamps. Since there is more clearance for clamping provided by the drill press add-on, the handheld C-clamps are able to grip onto the table 1 and the work piece easily. A handheld C-clamp is a hand-held clamp that can be used to grip especially small and delicate work pieces. Another benefit of the handheld C-clamps is their traction ability. The clamps have pads which are the components that come into contact with the work piece by directly gripping onto the work piece's surface. These pads are strong enough to grip the surface of the work piece without slipping, yet delicate enough to keep the surface of the work piece damage-free. Also, the handheld C-clamps are made of strong metal and typically anti-corrosive and are therefore durable for any type of clamping job.

However, it is still important to remember that it is not necessary to the function of the drill press table to use C-clamps or handheld C-clamps. A drill press vise, which is the standard clamp to use for drill presses, can still be easily used with the drill press table if desired. Also, the drill press table can be drilled and taped for other applications as necessary. This avoids damage to the original drill press table.

If the work piece is not securely attached to the surface of the drill press then there is a possibility that the work piece will move from its original position. This is dangerous because the drill press uses sharp drill bits at a high speed, which can cut through materials easily. The machine could very easily injure a person if something were to be out of place. Also, having the work piece not securely attached to the drill press raises the danger of having the work piece move in the midst of operating the drill press. This is an issue because it could cause the drill press cutting tool to pierce through the wrong part of the work piece, creating a hole in an undesired position. While the drill press vise can be used for regular sized work pieces, the drill press table provides extra security for the work pieces that are either too small or too large for the drill press vise to secure tightly. The versatility of the drill press table allows the use of any type of clamp, including the drill press vise whereas the traditional drill press allows only for the use of the drill press vise for a thorough hold on the work piece.

In reference to FIG. 2 and FIG. 3, presently, the plurality of support legs 5 are made from one and a half inch slices of a three inch by six inch steel square tube. While these specific dimensions are used in the current embodiment, the plurality of support legs 5 used on the drill press table are not limited to those dimensions. Other sizes of tubes can be used if desired, including but not limited to, four inches by eight inches or six inches by six inches, depending on the clearance between the apparatus and the drill press table desired. The support legs 5 provide an added height for clamping clearance between the drill press table and the table 1. The legs 5 are clamped to the top of the original drill press table. This secures the tabletop plate 8 to the drill press. The legs 5 then clamp to or can be bolted to the original drill press or mill table. Presently, the two steel tube legs 5 provide clearance for clamping objects to the tabletop plate 8. It is quick and simple to secure an object to be drilled to the tabletop plate 8. Similar to the other components of the drill press table, the support leg configuration is not limited to using two steel square tubes. Other leg configurations may be used to deliver the same function as the current steel square tubes. The easy clamping ability is one of the more important features of the drill press table and as a result, any variation of the support system 4 and support legs 5 that are still able to provide easy clamping of work pieces onto the tabletop plate 8 is usable. For the current embodiment, the support legs 5 can be cut with a steel cutting band saw or chop saw and customized to a desired height.

Referring to FIG. 1, FIG. 2, FIG. 3, and FIG. 4, the flat head screws 6 are used to secure the table 1 to the support legs 5. The present embodiment uses, but is not limited to, a plurality of five-sixteenths of an inch flat head machine screws 6. Other sizes of screws may be used as the purpose of the screws remains the same, regardless of size. The table plate 8 attaches via flat head machine screws 6 and nuts to the table legs 5. The screws 6 chosen are flat head so they do not interfere with the smooth, flat surface of the tabletop plate 8. It is important to keep the tabletop plate 8 flat because that is the surface upon which the work piece will rest when using a drill press. An uneven surface will make the work piece lay unbalanced atop the table 1 and increase the probability of an uneven or improper cut of the work piece.

In reference to FIG. 1, FIG. 2, FIG. 3, and FIG. 4, to ensure that the screws 6 are held securely in the holes 3 of the table 1, locking nuts 7 are placed on the screws 6. The locking nuts 7 act as a protective measure for the connection between the table 1 and the support system 4. Without the locking nuts 7, the drill press table would have the potential to face many problems. The main issue would be not having a secured attachment of the table 1 to the support system 4. The screws 6 alone are not enough to tightly attach the table 1 to the support system 4 because eventually the screws 6 will come loose from the holes 3 and the drill press table has a chance of falling apart. The locking nuts 7 will prevent the screws 6 from unscrewing out of the holes 3.

In reference to FIG. 4, another variation consists of using a melamine particle board can be added to the top of the steel (or other strong metal) plate 1 for wood working projects. Melamine is treated on both sides to create more durable surfaces that are suitable for a lot of wear. This is convenient when using it with a drill press. Many times, the drill bits for the drill press will most likely make contact with the surface of table 1. For wood projects, a melamine particle board will obtain less damage than the original drill press table. This adds to the durability of present invention. Even without the added melamine particle board, the table 1 is also very durable. Its durability is not only a consequence of using a strong metal material as discussed but also because of an added anti-corrosion coating that can be painted on the table 1. The anti-corrosion coating behaves as a preemptive protective measure against the rusting and corrosion of the table 1. Both the melamine particle board and the anti-corrosion coating add to the longevity of the drill press table and the drill press itself.

Also in reference to FIG. 1, another benefit of using the drill press table is the ability to still use an angle iron or wood fence. The shape of the table 1 is minimal enough in design that the angle iron and the wood fence can easily be clamped to the tabletop plate 8 for ease of set up.

The drill press table is useful to any wood worker, metal worker, machinist, handyman, whoever uses or has used a drill press or mill. Its unique design features and versatility enables the present invention to be used for any drill press or mill.

Although the invention has been explained in relation to its preferred embodiment, it is to be understood that many other possible modifications and variations can be made without departing from the spirit and scope of the invention as hereinafter claimed.

What is claimed is:

1. The drill press table comprises,
a table;
a support system;
the table resting atop the support system; and
the table comprises of a concave edge, a tabletop plate, and a plurality of holes.

2. The drill press table as claimed in claim 1 comprises,
the support system comprises of a plurality of support legs, a plurality of flat head screws, and a plurality of locking nuts.

3. The drill press table as claimed in claim 1 comprises,
the concave edge being an edge of the table that is curved in; and
the plurality of holes traversing through the tabletop plate.

4. The drill press table as claimed in claim 2 comprises,
the plurality of support legs being attached to the table;
the plurality of flat head screws securing the plurality of support legs to the table;
the plurality of flat head screws traverses through the plurality of holes; and
the plurality of locking nuts securing the plurality of flat head screws to the plurality of support legs and the table.

5. The drill press table comprises,
a table;
a support system;
the table resting atop the support system;
the table comprises of a concave edge, a tabletop plate, and a plurality of holes; and
the support system comprises of a plurality of support legs, a plurality of flat head screws, and a plurality of locking nuts.

6. The drill press table as claimed in claim 5 comprises,
the concave edge being an edge of the table that is curved in; and
the plurality of holes traversing through the tabletop plate.

7. The drill press table as claimed in claim 5 comprises,
the plurality of support legs being attached to the table;
the plurality of flat head screws securing the plurality of support legs to the table;
the plurality of flat head screws traverses through the plurality of holes; and
the plurality of locking nuts securing the plurality of flat head screws to the plurality of support legs and the table.

8. The drill press table comprises,
a table;
a support system;
the table resting atop the support system;
the table comprises of a concave edge, a tabletop plate, and a plurality of holes;
the support system comprises of a plurality of support legs, a plurality of flat head screws, and a plurality of locking nuts;
the concave edge being an edge of the table that is curved in;
the plurality of holes traversing through the tabletop plate;
the plurality of support legs being attached to the table;
the plurality of flat head screws securing the plurality of support legs to the table;
the plurality of flat head screws traverses through the plurality of holes; and
the plurality of locking nuts securing the plurality of flat head screws to the plurality of support legs and the table.
